(19) United States
(12) Patent Application Publication
(10) Pub. No.: US 2025/0172756 A1
(43) Pub. Date: May 29, 2025

(54) WAVEGUIDE HAVING COMBINED PUPIL EXPANDER AND OUTPUT COUPLER

(71) Applicant: GOOGLE LLC, Mountain View, CA (US)

(72) Inventors: Ruoping Li, Montreal (CA); Shreyas Potnis, Kitchener (CA); Timothy Paul Bodiya, Toronto (CA)

(21) Appl. No.: 18/724,718

(22) PCT Filed: Nov. 30, 2022
(86) PCT No.: PCT/US2022/051347

§ 371 Date: Jun. 27, 2024

Related U.S. Application Data
(60) Provisional application No. 63/294,471, filed on Dec. 29, 2021.

(51) Int. Cl. G02B 27/01

(52) U.S. Cl. CPC G02B 6/34

(57) ABSTRACT

An augmented reality (AR) display system includes a light source and a lens element having a waveguide to direct display light from the light source toward a user's eye. The waveguide includes an incoupler (IC) having surface relief gratings (SRGs) in a first region of the waveguide to incouple the display light and a combined exit pupil expander (EPE) and outcoupler (OC) having surface relief gratings at a second region of the waveguide for exit pupil expansion and surface relief gratings at a third region of the waveguide for outcoupling the display light from the waveguide. The second and third regions at least partially overlap laterally relative to the expected position of the user's eye, with the surface relief gratings of the second region being formed on the same or opposite side of the waveguide as the surface relief gratings of the third region.

### BACKGROUND

Augmented reality (AR) display systems typically utilize an optical combiner that combines light from the real world and light from a display, which may represent computer-generated imagery or recorded imagery, for output toward at least one eye of a user. One common type of optical combiner is a waveguide (also commonly referred to as a “lightguide”) used to transfer light from a light source (e.g., a projector or micro-display) toward a user's eye, while being substantially transparent to incident light from the surrounding environment. Display light from the light source enters the waveguide through an incoupler (IC) and is propagated through the waveguide via total internal reflection (TIR) or other internal propagation techniques, and then is output toward the user's eye via an outcoupler (OC). Further, in order to expand the eyebox, an exit pupil expander (EPE) may be implemented in the light path between the IC and OC in the waveguide. In some implementations, the IC, EPE, and OC are implemented at the waveguide in the form of surface relief gratings. However, the use of surface relief gratings in waveguides risks the introduction of rainbow artifacts due to diffraction of lights sources in the real environment, such as indoor lighting, streetlights, car headlights, the sun, and the like. Moreover, waveguides utilizing surface relief gratings in this manner tend to be very sensitive to incident angles of the display light, which manifests in bad color uniformity across the field of view. To correct for this, the red-green-blue (RGB) colors from the image source are adjusted such that the final image is only as bright as the minimum brightness across the entire field of view. This makes the image appear uniform when viewed by the user, while severely limiting the effective display brightness.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a diagram illustrating a rear perspective view of an AR near-eye display device utilizing a waveguide with combined EPE and OC gratings in accordance with some embodiments.

FIG. 2 is a diagram illustrating rear view of a lens element implementing the waveguide of FIG. 1 in accordance with some embodiments.

FIG. 3 is a diagram illustrating a cross-section view of an example implementation of the waveguide of FIG. 2 in accordance with some embodiments.

FIG. 4 is a diagram illustrating a cross-section view of another example implementation of the waveguide of FIG. 2 in accordance with some embodiments.

FIG. 5 is a diagram illustrating the rear view of the lens of FIG. 2 with a projection of component wavelengths of RGB display light traveling between IC gratings and a combined EPE and OC gratings of the waveguide of FIGS. 2-4 in accordance with some embodiments.

FIG. 6 is a k-space diagram of the component wavelengths of RGB display light traveling through the waveguide of FIG. 5 in accordance with some embodiments.

FIG. 7 is a flow diagram illustrating a method of use of the AR near-eye display device of FIGS. 1-6 in accordance with some embodiments.

### DETAILED DESCRIPTION

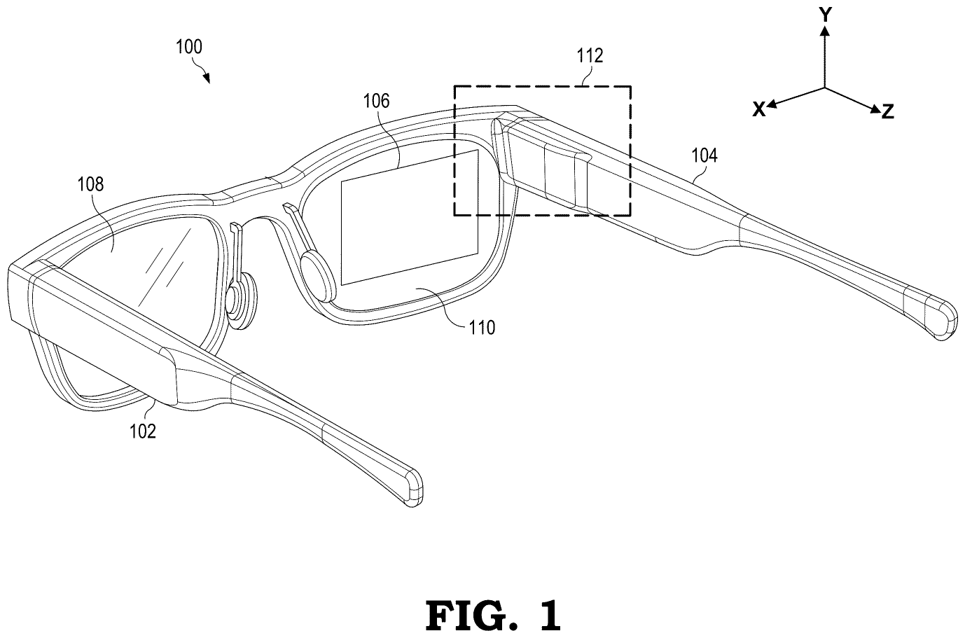

FIGS. 1-7 illustrate systems and techniques for a diffractive waveguide employing an input coupler (IC) and a combined exit pupil expander (EPE) and output coupler (OC) using surface relief gratings (SRGs). The IC is implemented as a set of SRGs in a first region of the waveguide and the combined EPE/OC is implemented as SRGs in a second region and third region of the waveguide, whereby the second region and third region at least partially overlap laterally (that is, with respect to the user's eye when it is at its expected position relative to the waveguide). The SRGs of the second region provide exit pupil expansion for display light propagated in the waveguide, while the SRGs of the third region provide outcoupling for the so-expanded display light. In this approach, the second region and third region can be formed as one-dimensional (1D) gratings on opposite sides of the waveguide, or they may be implemented on the same side of the waveguide (e.g., on the eye-facing side of the waveguide), with 1D gratings used in the one or more non-overlapping sub-regions and two-dimensional (2D) gratings used in the one or more overlapping sub-regions, with the 2D gratings thus providing both EPE and OC functionality. Under this approach, the total lateral area of the waveguide occupied by SRGs is reduced, which leads to a reduction in the risk and/or magnitude of the rainbow effect or other visual artifacts caused by diffractive gratings. Moreover, by overlapping the EPE and OC, the overall light path length between the IC and OC can be shortened, which can provide improved maximum efficiency of the waveguide.

FIG. 1 illustrates an example AR display system 100 implementing a waveguide having combined EPE and OC gratings in accordance with implementations. The AR display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102 further can include one or more batteries or other portable power sources for supplying power to the electrical components of the AR display system 100. In some embodiments, some or all of these components of the display system 100 are fully or partially contained within an inner volume of support structure 102, such as within the arm 104 in region 112 of the support structure 102. In the illustrated implementation, the AR display system 100 utilizes a spectacles or eyeglasses form factor. However, the AR display system 100 is not limited to this form factor and thus may have a different shape and appearance from the eyeglasses frame depicted in FIG. 1.

One or both of the lens elements 108, 110 are used by the AR display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the display system 100. Additionally, the waveguide employs an exit pupil expander (EPE) in the light path between the IC and OC in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

In at least one embodiment, the IC, OC, and EPE are at least partially implemented using surface relief gratings (SRGs). However, unlike conventional approaches in which the gratings for each of the IC, OC, and EPE occupy entirely separate and distinct lateral regions of the corresponding waveguide, in at least one embodiment, the waveguide of at least one of the lens elements 108, 110 implements combined OC and EPE gratings in which, relative to a lateral extent of the waveguide/lens element, the gratings that provide EPE functionality (that is, exit pupil expansion) and the gratings that provide OC functionality (that is, outcoupling of display light from the waveguide toward a user's eye) at least partially overlap. Moreover, as described below, the parameters of these gratings (dimensions, order, direction, location, etc.) are co-designed so as to leverage this at least partial overlap. As a result, the overall lateral area occupied by the gratings of the IC, EPE, and OC is less than the lateral area occupied by conventional separate and distinct IC, EPE, and OC, and thus exhibits a reduced rainbow effect, while also providing a higher maximum waveguide efficiency due to the shorter path taken by the display light from the IC to the OC, which can facilitate the use of the AR display system 100 in daylight conditions.

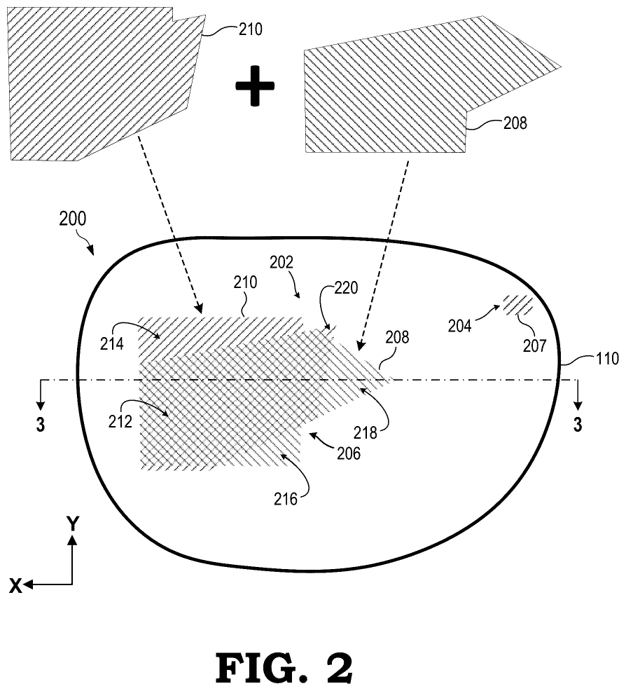

FIG. 2 illustrates a rear view 200 (that is, the view from the perspective of the expected location of the user's eye) of an example of such a waveguide implemented in, for example, the lens element 110 of the AR display system 100 in accordance with some embodiments. In the depicted example, the lens element 110 is implemented as an ophthalmic or non-ophthalmic lens composed of one or more substantially transparent materials, such as glass, plastic, or a combination thereof. The lens element 110 may be implemented as, for example, a monolithic substrate of transparent material upon which one or more layers or films are positioned, such as layers or films for polarization films, anti-reflection, tinting, or ultra-violet (UV) light protection. In other implementations, the lens element 110 may be formed from two or more separate substantially transparent pieces fixed or adhered together using, for example, optical adhesives, screws, or other mechanical techniques.

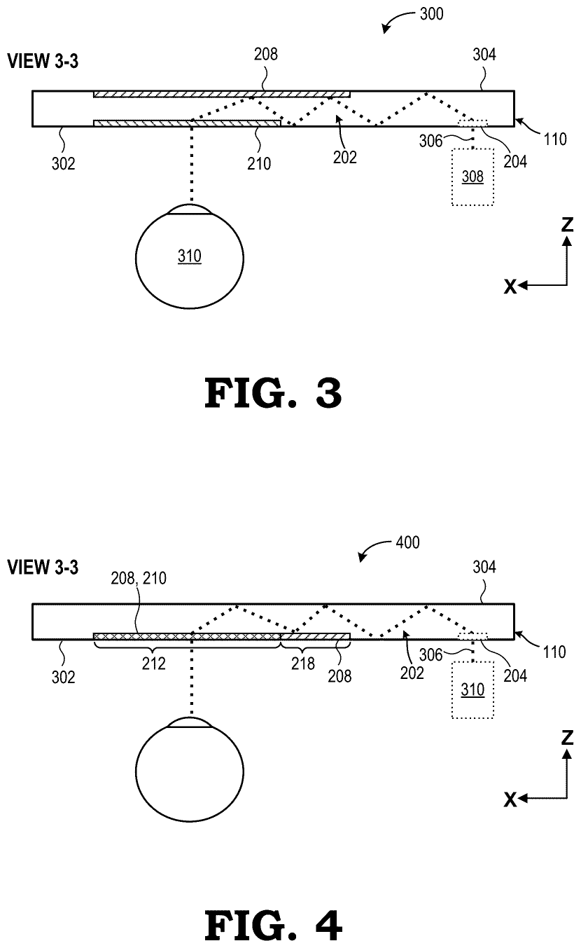

The lens element 110 implements a waveguide 202 that includes an incoupler (IC) 204 and a combined EPE/OC 206. The IC 204 includes a set of SRGs formed at a region 207 of the lateral extent (that is, along the illustrated X-Y plane) of the waveguide 202, with this set of SRGs configured to receive display light from a light source (see FIG. 3) and to direct the display light through the waveguide 202 via TIR or another propagation mechanism toward the combined EPE/OC 206. The combined EPE/OC 206, in turn, includes a set of SRGs formed at a region 208 of the lateral extent of the waveguide 202 and a set of SRGs formed at a region 210 of the lateral extent of the waveguide 202 such that the regions 208 and 210 at least partially overlap laterally (that is, along the X-Y plane or relative to the perspective of a user's eye at an expected position), resulting in a laterally overlapping sub-region 212. The SRGs formed in the region 208 provide EPE functionality in that they function to expand the exit pupil for the display light received from the IC 204 within the waveguide 202, while the SRGs formed in the region 210 provide OC functionality in that they function to outcouple display light from the waveguide 202 toward the user's eye, including display light reflected and diffracted from the SRGs in the region 208. Hence, with this at least partial lateral overlap and combination of functionality, the two regions 208, 210 together form the “combined” EPE/OC 206 from the perspective of the user's eye when looking into the lens element 110.

The lines illustrated in each of regions 207, 208, and 210 illustrate the general orientation of the SRGs for the corresponding region for the particular shapes, positions, and dimensions of the regions 207, 208, and 210. However, a waveguide implemented with an IC and a combined EPE/OC as described herein is not limited to the particular shapes, dimensions, and/or positions illustrated by the example of FIG. 2, but instead may assume any of a variety of shapes, dimensions, and/or positions depending on various parameters regarding the waveguide implementing the IC and combined EPE/OC, such as the dimensions of the lens element implementing the waveguide, the type, intensity, and other parameters of the light source, the type(s), orders, and dimensions of the SRGs implemented for the IC and combined EPE/OC, the distances between regions, the material(s) used in the manufacture of the SRGs or the waveguide 202 itself, and the like. Moreover, it will be appreciated that the regions 208, 210 are designed in conjunction, such that the design parameters of region 208 impact the design parameters of region 210, and vice versa, and thus a final design for each region 208, 210 (as well as for IC 204) may be achieved through an iterative modeling process, including the iterative testing of multiple parameters, which can be done either using simulation (using optimization tools in software) or by physical experiments and measurements (using physical optical setups). One or more design engineers would evaluate the results and reiterate by modifying the parameters or fine tuning them.

As described in greater detail below, the SRGs of regions 208 and the SRGs of region 210 may be formed on the same side of the waveguide 202 or on opposite sides of the waveguide 202. For example, the SRGs of region 208 may be formed on the world-facing side of lens element 110 while the SRGs of region 210 are formed on the eye-facing side of lens element 110, or the SRGs of region 208 may be formed on the eye-facing side of lens element 110 while the SRGs of region 210 are formed on the world-facing side of lens element 110. In other embodiments, the SRGs of both regions 208, 210 are formed on the same side of the waveguide 202, such as both regions 208, 210 formed on the world-facing side of the waveguide 202 or both regions 208, 210 formed on the eye-facing side of the waveguide 202. When formed on opposite sides of the waveguide 202/lens element 110, the SRGs of the regions 208, 210 each may be formed of one-dimensional (1D) gratings. When formed on the same side of the waveguide 202/lens element 110, the SRGS of the non-overlapping sub-regions (e.g., non-overlapping sub-regions 214, 216, 218, 220 for the example configuration in FIG. 2) may be implemented using 1D gratings, whereas in the overlapping sub-region(s) (e.g., overlapping sub-region 212 in the example configuration of FIG. 2) two-dimensional (2D) gratings may be formed to provide the grating for both region 208 and region 210 in the overlapping sub-region(s). For 1D gratings, any of a variety of 1D grating structures may be used. For example, the 1D gratings can be formed from gratings formed from a high-index material and encapsulated with a low-index material, or vice versa. For 2D gratings, any of a variety of 2D grating structures may be employed. For example, the 2D gratings could be formed from an array of rectangular pillars, cylindrical pillars, or pillars of arbitrary shape or cross-section. Moreover, either or both of the 1D gratings or 2D gratings can be formed from one or more metamaterials. Further, it will be appreciated that various parameters of the 1D/2D gratings may be tuned for relative efficiency or other properties by tuning various parameters, such as the size, height, shape, orientation, and/or order [e.g., −1, 0, +1] of the gratings, and the gratings at different locations within a given region may have different parameters for purposes of, for example, efficiency or color/intensity uniformity. Moreover, although not illustrated, in some embodiments additional regions with SRGs or other types of gratings may be implemented at least partially surrounding the regions 208, 210 (which, in this case, represent the minimum grating outlines produced by a field tracing as described below) so as to better balance uniformity across the field of view and the eyebox formed therefrom.

To illustrate, FIG. 3 depicts a cross-section view 300 of an implementation of the lens element 110 of FIG. 2 along cut-line 3-3. Note that for purposes of illustration, at least some dimensions in the Z direction are exaggerated for improved visibility of the represented aspects. In this example implementation, the waveguide 202 implements the SRGs of the region 208 on the opposite side of the waveguide 202 as the SRGs of the region 210. In particular, the SRGs of the IC 204 are implemented on the eye-facing side 302 of the lens element 110 (note that the IC 204 is not in-plane along cutline 3-3 but is included in the cross-section view 300 for purposes of illustration. Likewise, the SRGs of region 210 (which provide the OC functionality of the combined EPE/OC 206) are implemented at the eye-facing side 302. Further in this implementation, the SRGs of region 208 (which provide the EPE functionality of the combined EPE/OC 206) are implemented at the world-facing side 304 of the lens element 110 opposite the eye-facing side 302. Thus, under this approach, display light 306 from a light source 308 is incoupled to the waveguide 202 via the IC 204, and propagated (through TIR in this example) toward the region 208, whereupon the SRGs of the region 208 diffract the incident display light for exit pupil expansion purposes, and the resulting light is propagated to the SRGs of the region 210, which output the display light toward a user's eye 312. In other implementations, the regions 208 and 210 may switch sides, with the SRGs of region 210 formed on the world-facing side 304 and the SRGs of region 208 formed on the eye facing side 302, however, this may result in the regions 208 and 210 having different positions, dimensions, and shapes, and also may require SRGs in each region to have different characteristics.

FIG. 4 illustrates a cross-section view 400 of a different implementation of the lens element 110 of FIG. 2 along the cut-line 3-3. As with view 300, at least some dimensions in the Z direction are exaggerated for improved visibility and the IC 204 is included in the cross-section view 400 for illustrative purposes even though the IC 204 is not in-plane with the cut-line 3-3. In this implementation, the SRGs for both regions 208, 210 are formed at the same side of the waveguide 202, in this case the eye-facing side 302 of the lens element 110. Note that in other embodiments, the regions 208, 210 could instead be formed at the world-facing side 302 of the lens element 110. As shown by FIG. 2, the cut-line 3-3 runs through the non-overlapping sub-region 218 contains only the gratings for the region 208, which may therefore implement 1D gratings, as well as through the overlapping sub-region 212 that contains gratings for the region 208 as well gratings for the region 210, and thus implements 2D gratings to impart the appropriate diffractive actions on incident display light 306 in providing both EPE functionality as provided by region 208 as well as outcoupling functionality as provided by region 210.

By employing SRGs for EPE functionality and SRGs for OC functionality which at least partially overlap laterally (from the perspective of the expected position of the user's eye), the waveguide 202 provides IC, EPE, and OC functionality with a reduced lateral area relative to conventional approaches with laterally separate IC, EPE, and OC. This reduction in the total area containing SRGs commensurately lowers the magnitude and risk of the rainbow effect and other visual effects caused by the light diffraction introduced by SRGs. Moreover, the combination of EPE and OC so that they at least partially overlap results in a shorter light path between the IC and OC, and thus resulting in increased maximum waveguide efficiency, which in turn makes daylight use more feasible.

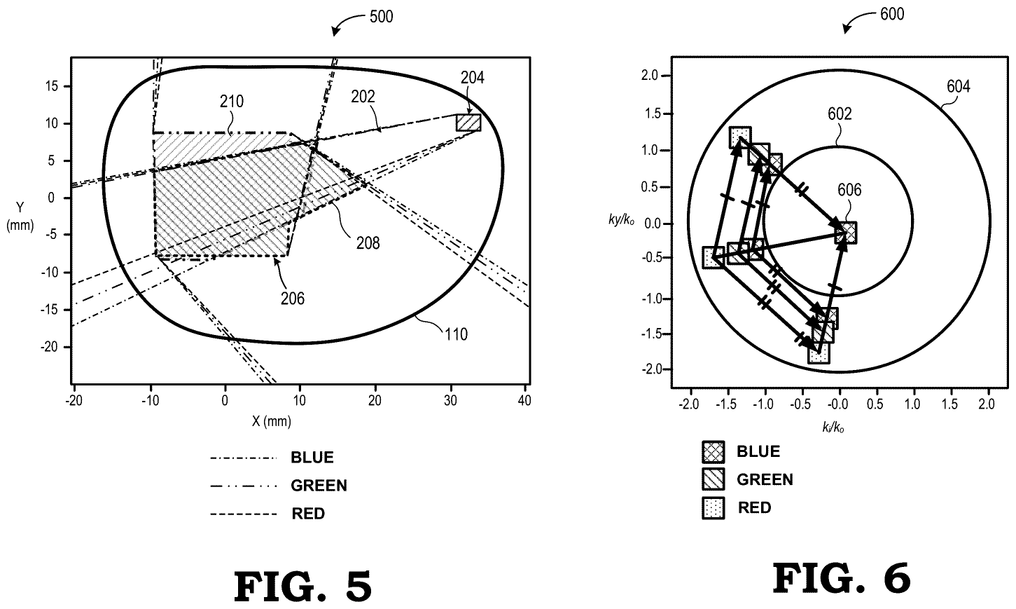

FIGS. 5 and 6 together illustrate an example behavior of component wavelengths of RGB display light traveling through the waveguide 202 of the lens element 110, with FIG. 5 illustrating a view 500 of the component R, G, and B wavelengths of display light incoupled via the IC 204 and projected toward the combined EPE/OC 206, and FIG. 6 illustrating a normalized k-space representation 600 of the R,G, B component wavelengths of the display light propagating through the waveguide 202. The k-space diagram is a tool used in optical design to represent directions of light rays that propagate within a waveguide. Its horizontal and vertical axes represent the x and y (horizontal and vertical) components of ray directions relative to the user's eye. In the k-space representation 600 (with k being the reciprocal of wavelength, such that k=1/λ), an inner refractive boundary 602 is depicted as a circle with radius of n=1, the refractive index associated with the external transmission medium (air); outer refractive boundary 602 corresponds to a refractive index of the diffractive waveguide 202 of FIG. 2.

In the context of the k-space representation 600, for RGB display light (e.g., full-color AR content) to be successfully and accurately directed to an eye of a user via a waveguide with the indicated refractive index (such as diffractive waveguide 202), each red, green, and blue component of that RGB display light enters the waveguide 202 from an external position 606, which is included in the space depicted within inner refractive boundary 602. The color components are directed along one or more paths within a volume of the waveguide 202 (the space depicted between inner refractive boundary 602 and outer refractive boundary 604) and are then redirected to exit the waveguide (and thereby return to the external space within inner refractive boundary 602). Display light components represented between the inner refractive boundary 602 and outer refractive boundary 604 are propagated to the user via the waveguide 202. Any display light components represented outside the outer refractive boundary 602 (of which there are none in the k-space representation 600) are non-propagating, such as those that are either lost externally or comprise an imaginary component (such that it only appears in mathematic modeling of the display light component).

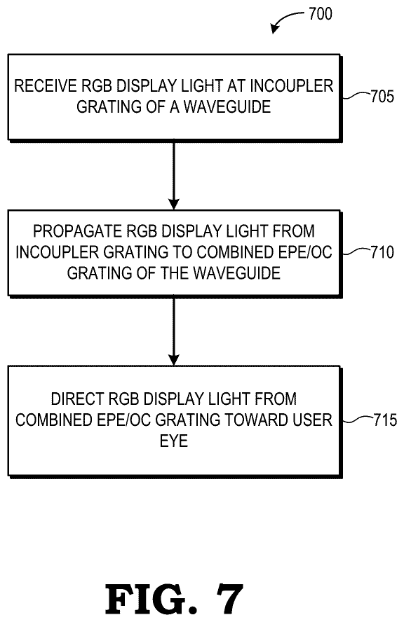

In operation, and with reference to FIGS. 2-5, each RGB component of the RGB display light originating from refractive position 606 to be directed through diffractive waveguide 202 is provided to the volume of the diffractive waveguide via IC 204. Referring now to FIG. 7, an example method 700 of operation of the AR display system 100 of FIG. 1 implementing the waveguide 202 of FIGS. 2-6 having a combined EPE/OC 206 is described in accordance with some embodiments. At block 705, a light source (e.g., light source 310) generates RGB display light (e.g., display light 306), which is received at the SRGs of the IC 204, which through the diffraction provided by the SRGs causes the incident display light to be incoupled into the waveguide 202 in the lens element 110. At block 710, the incoupled display light is then propagated to the SRGs of the combined EPE/OC 206 through TIR or other phenomena, whereupon the exit pupil represented by the display light is expanded and the resulting display light is outcoupled from the waveguide 202 and, at block 715, directed toward a user's eye.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A device comprising:
a waveguide comprising:
an incoupler (IC) having surface relief gratings at a first region; and
a combined exit pupil expander (EPE) and output coupler (OC) having surface relief gratings at a second region and a third region of the waveguide, wherein the second region and the third region at least partially overlap laterally relative to an expected position of a user's eye.

2. The device of claim 1, wherein:
the surface relief gratings at the second region provide exit pupil expansion functionality for display light propagated in the waveguide; and
the surface relief gratings at the third region provide outcoupling functionality for display light propagated in the waveguide.

3. The device of claim 1, wherein:
the second region is formed on a first side of the waveguide and the third region is formed on an opposing second side of the waveguide.

4. The device of claim 1, wherein:
the third region is formed on a first side of the waveguide and the second region is formed on an opposing second side of the waveguide.

5. The device of claim 3, wherein the surface relief gratings of the second region and the surface relief gratings of the third region are one dimensional (1D) gratings.

6. The device of claim 1, wherein the second region and the third region are formed on a same side of the waveguide.

7. The device of claim 6, wherein the second region and third region overlap in at least one overlapping sub-region and do not overlap in at least one non-overlapping sub-region.

8. The device of claim 7, wherein the surface relief gratings in the at least one overlapping sub-region are two-dimensional (2D) gratings and the surface relief gratings in the at least one non-overlapping sub-region are one-dimensional (1D) gratings.

9. The device of claim 8, wherein the 2D gratings comprise at least one of: rectangular pillars, cylindrical pillars, pillars of arbitrary shape and cross-section; or metamaterials.

10. The device of claim 6, wherein the first region, the second region, and the third region are formed on a same side of the waveguide.

11. The device of claim 6, wherein the first region is formed on a first side of the waveguide and the second region and the third region are formed on an opposing second side of the waveguide.

12. The device of claim 3, wherein the surface relief gratings of the first region and the surface relief gratings of the third region are formed at a same side of the waveguide.

13. The device of claim 1, wherein the second region and the third region partially overlap laterally relative to the expected position of the user's eye.

14. The device of claim 1, further comprising:
a lens element, the lens element comprising the waveguide;
a support frame to support the lens element and configured to mount to a head of a user; and
a light source to generate display light for incoupling into the waveguide via an IC.

15. (canceled)

16. A method comprising:
providing a waveguide including an incoupler (IC) having surface relief gratings at a first region, a combined exit pupil expander (EPE), and output coupler (OC) having surface relief gratings at a second region and a third region of the waveguide, wherein the second region and the third region at least partially overlap laterally relative to an expected position of a user's eye;
incoupling display light to the waveguide via the IC;
propagating the incoupled display light to the combined EPE and OC; and
outcoupling display light with an expanded exit pupil from the waveguide via the combined EPE and OC.

17. The method of claim 16, wherein:
the surface relief gratings at the second region provide exit pupil expansion functionality for display light propagated in the waveguide; and
the surface relief gratings at the third region provide outcoupling functionality for display light propagated in the waveguide.

18. The method of claim 16, wherein either:
the second region is formed on a first side of the waveguide and the third region is formed on either an opposing second side of the waveguide; or
the third region is formed on a first side of the waveguide and the second region is formed on an opposing second side of the waveguide.

19. The method of claim 16, wherein the second region and the third region are formed on a same side of the waveguide.

20. The method of claim 19, wherein the second region and third region overlap in at least one overlapping sub-region and do not overlap in at least one non-overlapping sub-region.

21. The method of claim 20, wherein the surface relief gratings in the at least one overlapping sub-region are two-dimensional (2D) gratings and the surface relief gratings in the at least one non-overlapping sub-region are one-dimensional (1D) gratings.
